(19) United States
(12) Patent Application Publication
(10) Pub. No.: US 2026/0244842 A1
(43) Pub. Date: Aug. 20, 2026

(54) TECHNIQUES FOR ARTIFICIAL INTELLIGENCE SUPPORTED, REAL-TIME CONTINUOUS DELIVERY OF MULTILINGUAL CONTENT WITH LEARNING AND PREDICTIVE FUNCTIONALITY

(71) Applicant: SAP SE, Walldorf (DE)

(72) Inventors: Michail Vasiltschenko, Schriesheim (DE); Miriam Ullrich, Heidelberg (DE); Stephen Johnson, Heidelberg (DE); Miguel Rolando Heineken, Rauenberg (DE); Jan Schrage, Helmstadt (DE)

(21) Appl. No.: 19/056,024

(22) Filed: Feb. 18, 2025

(51) Int. Cl. G06F 40/166; G06F 3/0481; G06F 40/58

(52) U.S. Cl. CPC G06F 40/166; G06F 3/0481; G06F 40/58

(57) ABSTRACT

In some implementations, the techniques may include receiving a first input indicating a request for modifying a displayed translation. In addition, the techniques may include receiving a second input indication a portion of the displayed translation. The techniques may include determining domain information for the portion of the displayed translation. The techniques may include accessing a data repository for a modified translation based at least in part on the domain information. When the modified translation is not stored in the data repository techniques may include receiving the modified translation from an expert user and storing the modified translation and the domain information in the data repository. The techniques may include modifying the displayed translation using the modified translation. The techniques may be performed on one or more computing devices. The techniques may be performed by a system or stored as a series of instructions on a computer-readable tangible medium.

### BACKGROUND

Machine translation (MT) of language has made significant strides over the years, but there are still challenges and issues associated with it. Some of the key challenges include loss of context, ambiguity, incorrect grammar and syntax, lack of understanding of culture nuances, use of idioms and phrasal verbs, improper tone and style, lack of deep understanding, inconsistent quality of translations, ethical concerns, and inadequate training data.

Machine translation often struggles with understanding context. Words and phrases can have multiple meanings depending on the context, and MT systems may not always choose the most appropriate translation. This is particularly evident in idiomatic expressions, slang, or specialized terminology.

Ambiguity is a common issue in language, where a single word or sentence can have multiple interpretations. Machines can have difficulty disambiguating these meanings without a deeper understanding of the surrounding context or intent.

Different languages have varying sentence structures, grammatical rules, and word orders. MT systems might produce translations that are grammatically incorrect or awkward in the target language. Even with advanced models, translating complex sentence structures can still be problematic.

Language can be deeply intertwined with culture. Some concepts or phrases may not have direct equivalents in other languages, leading to mistranslations. Often translations can misinterpret similar terms resulting in a difference in the precise legal language definitions. In all languages, there are some linguistic gaps (e.g., a term may not exist with the same meaning as in a source language). In such cases the MT will “invent something” or do the word-by-word translation. MT often misses these cultural nuances, which can lead to translations that feel unnatural or even offensive in certain contexts.

Idiomatic expressions and phrasal verbs are often difficult for machine translation systems to handle. These types of phrases do not translate literally and require a more nuanced understanding of the language to render accurately in another language.

MT systems may have trouble conveying the tone, formality, or style of the original text. A translation might sound too formal, too casual, or not capture the subtleties of the original writer's voice, which can change the meaning or feel of the text.

Machine translation systems typically lack deep comprehension of the languages they are working with. These systems can rely heavily on statistical and pattern-based algorithms rather than true understanding, which limits their ability to handle nuanced or complex sentences effectively.

While modern MT systems, especially neural machine translation (NMT), have improved significantly, the quality can vary greatly depending on the language pair, the domain (e.g., technical vs. conversational), and the complexity of the text. Some languages or subject areas may still produce lower-quality translations.

Machine translation systems can struggle with non-standard language use, such as regional dialects, informal speech, or user-generated content (e.g., social media posts, text messages).

The potential for biased translations, especially when MT systems are trained on data that can reflect societal prejudices, is an ongoing concern. For instance, gender or racial biases might be inadvertently reflected in translations, perpetuating stereotypes.

MT models are only as good as the data that the systems are trained on. If the training data lacks diversity or has inaccuracies, the translation quality will suffer. Also, for some languages with fewer resources or lesser representation in datasets, the quality of translations may be poor.

Software products often require translation of content to serve customers in various different languages. The correction and maintenance process for the languages can be time-consuming and slow. The current translation process for user interfaces is often based on worklists and for at design time. The traditional process cannot easily cope with the dynamically created in real-time strings with values.

Missing translations is also an issue for translating user interfaces. The problem is increasing due to the integration and re-use of texts from different components and/or microservices.

There is a need for agile and fast language delivery for cloud-based software products.

### SUMMARY

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

Often displayed content for software products is translated at design time. When there are updates to the software product, additional translations may need to be performed. In various business fields, such as legal, financial, logistics, human resources, and payroll precise legal terminology is important. Often machine translations services alone are not as precise as required for these fields. This requires an informed user (e.g., an expert user that is knowledgeable to the specific domain for the translation) to review the language prior to publication. For example, in a financial context, a financial expert user can review the translated terms and ensure the accuracy based on the domain.

However, a system in which the translation process is partially automated using stored domain specific translations can improve the process and overtime such a system will improve the precision of machine translations.

These types of human reviews can be limited to authorized users with specific domain information. This can provide more precise translations and prevalent inappropriate translations if the system were open for correction by any user.

Basic words can have quite different meanings based on the context. For example, in a dating context the word “interest” has a vastly different meaning than in a financial context.

Some legal expressions may be difficult to translate because the context needs to be known and expert review may be needed here. In one non-limiting example, the term “deduction” when translated into a different language (e.g., Italian) may have different meanings depending on the context. Italy has two types of deduction: “Deduzioni” which is deductions from gross before taxes, and “detrazioni” which is deductions from taxes. Both can be translated as deductions but in a legal context the language needs to be more specific. Especially in the reverse case of English to Italian.

Expert users can enhance the translation capabilities for various products and services by providing more accurate translation. Once these translations can be stored in a data repository that can quickly be accessed based on the domain information. As time proceeds and the data repository grows, there will be less need for any manual intervention making the process faster and more accurate. As products and services are developed, they can share this stored repository of domain specific translations.

In one general aspect, computer implemented methods may include receiving a first input indicating a request for modifying a displayed translation. The computer implemented method may also include receiving a second input indicating a portion of the displayed translation for which translation or modification may be required. The method may furthermore include determining domain information for the portion of the displayed translation. The method may include accessing a data repository for a modified translation based at least in part on the domain information. Wthe modified translation is not stored in the data repository the method may include receiving the modified translation from an expert user, and storing the modified translation and the domain information in the data repository. The method may also include modifying the displayed translation using the modified translation. Other embodiments of this aspect include corresponding computer systems, apparatus, and computer programs recorded on one or more computer storage devices, each configured to perform the actions of the methods.

Implementations may include one or more of the following features. The domain information may include metadata associated with a term of the modified translation. The computer implemented method may include accessing an edit mode for the displayed translation, and displaying a button to modify the displayed translation, where the first input is received from selected the button. The computer implemented method may include using one or more browser plug-ins to receive the first input and the second input to modify the displayed translation; and connecting to a domain service to receive the modified translation. The determining domain information for the portion of the displayed translation is based at least in part on a type of application for the displayed translation. The computer implemented method where the modified translation is based in part on a specific locality for the displayed translation. The computer implemented method one of the first input and the second input can be received via a chatbot.

Implementation of the described techniques may be performed by a system including various hardware components, as a method or process, or stored as a series of instructions on a computer-readable tangible medium.

The disclosed process can reduce time-to-market, costs, and provides high quality translations. Additionally, the improved process can eliminate a vast number of processes which will be obsolete. The process can follow a multilingual approach in real-time for any content and are using the learning capabilities of large learning models (LLMs). Using the decoupling of the texts from the product builds the process can ensure that the system provides multilingual version of different content with no missing translations (including customer's changes/modifications/enhancements and master data) by leveraging domain-specific domain specific databases. The focus is on the Local Product Manager. The texts could come from the database or from SAP Machine Translation (pre-trained on the SAP context).

This process creates enormous potential for gathering customers' changes, which will help not only understand why the customers are really using but predict the demand for new language versions. This process can eliminate the language barrier for any potential user and provide the user with the possibility to get all types of content independent from the technology stack in the language of the user in real-time. By using built-in feedback from domain experts this process can provide higher-quality translations than regular machine translation tools or LLMs and standard feedback processing in the outside world.

A developer on the customer side enhances the existing scenario and the texts can be translated in real-time and are reviewed by the key-user on the customer side (or implementation partner) who is the native speaker and domain expert. The changes can be used for the improvements of SAP MT (and/or SAP LLM).

An implementation partner or key-user on the customer side would like to change an SAP term to a term which is common in the customer's company.

Currently the customers can modify our standard translation with significant efforts (for example they have to defend these chances in order not to be overwritten with SPs/new releases every time). Using the approach of this IDF the customers will get the possibility to change the term within minutes for the relevant usages scenarios and distribute the changes to all employees in the company.

Communication Use Case: A new email has to be created for example for different SAP locations in different countries. Instead of drafting the email in English and then translate it, the Localized Personalization approach with GenAI can be used. This would mean that different email versions can be created in real-time in multi-lingual approach and reflect the local culture, specific interests etc. The versions can be reviewed by local communication experts and update the terminology database.

The following detailed description and accompanying drawings provide a better understanding of the nature and advantages of various embodiments of the present disclosure.

### BRIEF DESCRIPTION OF THE DRAWINGS

FIG. 1 illustrates an exemplary block diagram for a system for an exemplary use case incorporating the techniques within a web application.

FIG. 2 illustrates a notional swim lane diagram for an exemplary process for artificial intelligence supported, real-time continuous delivery of multilingual content with learning and predictive functionality incorporated within a web application.

FIG. 3 illustrates an exemplary block diagram for a system for an exemplary use case incorporating the techniques within a digital assistant.

FIG. 4 illustrates a notional swim lane diagram for an exemplary process for artificial intelligence supported, real-time continuous delivery of multilingual content with learning and predictive functionality incorporated within a digital assistant.

FIG. 5 illustrates a flowchart for an exemplary process for artificial intelligence supported, real-time continuous delivery of multilingual content with learning and predictive functionality.

FIG. 6 illustrates an exemplary computer system for implementing various embodiments described above.

FIG. 7 illustrates an exemplary computing device for implementing various embodiments described above.

FIG. 8 illustrates an exemplary system for implementing various embodiments described above.

### DETAILED DESCRIPTION

In the following description, for purposes of explanation, numerous examples and specific details are set forth to provide a thorough understanding of the present disclosure. It will be evident, however, to one skilled in the art that various embodiments of the present disclosure as defined by the claims may include some or all of the features in these examples alone or in combination with other features described below and may further include modifications and equivalents of the features and concepts described herein.

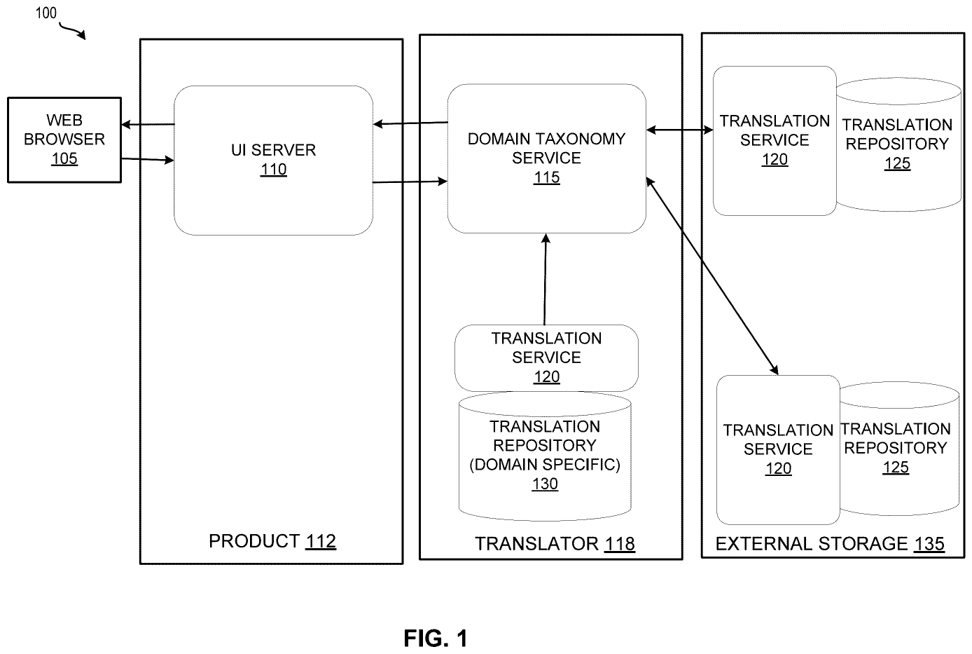

FIG. 1 illustrates an exemplary block diagram for a system 100 for implementing the techniques described herein. FIG. 1 illustrates an exemplary use case incorporating the techniques within a web application. In various embodiments, system 100 can include a web-browser 105, a product 112 (e.g., a software product), a translator 118, and an external storage 135.

A web-browser 105 is a software application that allows users to access, retrieve, and interact with content on the World Wide Web. It acts as a gateway to the Internet, translating complex web-based technologies into a user-friendly interface. The web-browser 105 can use a rendering engine to convert HTML, CSS, and JavaScript into visual content on the screen. The web-browser 105 can connect with a user interface server 110 for product 112. User Interface (UI) server 110 is a software component or service responsible for delivering and managing the presentation layer of an application. It serves the graphical user interface (GUI) or other front-end elements that allow users to interact with an application. The UI server 110 can handle the generation and delivery of web pages, dashboards, or application interfaces to the user's device. UI server 110 can serve HTML, CSS, JavaScript, and other assets necessary for rendering the user interface in a browser or client application. The UI server 110 can act as an intermediary between the front-end (user-facing) and back-end (data and logic layers) components. UI server 110 can send user inputs (like form submissions) to the back-end and retrieves data or updates to present to the user. UI server 110 can serve static or dynamic content to the client (e.g., a web browser) while relying on back-end APIs for business logic and data.

Product 112 can be a software application (often just called an App). The software application can provide a multitude of services (e.g., financial, business, government, etc.). The UI server 110 can interact with Domain Taxonomy Service 115, which can be part of the translator 118. Translator 118 can be a cloud translator.

A Domain Taxonomy Service 115 is a software system or service that manages, organizes, and provides access to a structured classification of information (taxonomy) within a specific domain or area of knowledge. It is often used to standardize how data is categorized and described across systems, facilitating consistency, interoperability, and easier data discovery.

Domain Taxonomy Service 115 can store hierarchical or relational structures representing the categories, terms, or concepts in a domain. Some examples can include but are not limited to scientific classifications, product categories, industry-specific terminology.

A Domain Taxonomy Service 115 can provide application programming interfaces or tools for querying and retrieving taxonomy data. It can allow users or systems to find terms, categories, or relationships efficiently.

A Domain Taxonomy Service 115 can be tailored to a particular area, such as healthcare, finance, e-commerce, education, or biology. For example, a taxonomy service for healthcare might classify diseases, symptoms, and treatments.

Domain Taxonomy Service 115 can track changes to taxonomies over time (e.g., adding unfamiliar terms, modifying relationships). It can ensure that updates are managed and approved to maintain consistency.

A Domain Taxonomy Service 115 can ensure integration with other systems. For example, it can support applications like search engines, recommendation systems, analytics tools, or knowledge graphs. It can help standardize metadata, making data more interoperable across systems.

A Domain Taxonomy Service 115 can support advanced structures, such as poly-hierarchies (where a concept belongs to multiple categories) or ontologies (which define relationships like “is a part of” or “is similar to”).

A Domain Taxonomy Service 115 can utilize OWL (Web Ontology Language), RDF (Resource Description Framework), SKOS (Simple Knowledge Organization System). Some taxonomy Management Tools can include but are not limited to PoolParty, Ontotext, Synaptica, or open-source tools.

The translation service 120 can receive input (e.g., a textual input) in one language and translate the inputs into one or more different languages. Training data can include datasets containing sentences in a source language paired with their translations in the target language. The input data can be tokenized or split into smaller units like words or sub words. The data can be cleaned and sometimes normalized to remove noise and inconsistencies. In various embodiments, an encoder can convert the input source language into a sequence of numerical vectors (or representations). The encoder can be used to capture the semantic and syntactic meaning of the text. A decoder can be used to generate the translation into the target language. This can be done word-by-word. The decoder can use the encoded representation and previously generated words to predict the next word. Attention mechanisms can be used to allow the translation algorithm to focus on specific parts of the source sentence while generating each word in the translation. This can improve the quality of the translation, especially for long and complex sentences. Transformer models can be used such as but not limited to BERT, GPT, or T5 to replace traditional recurrent neural networks (RNNs) with self-attention mechanisms for better efficiency and parallelism. The transformer models can capture context over entire sentences or paragraphs, making translations more accurate and contextually relevant.

A domain specific translation repository 130 can store translated words or phrases that are specific to a language or regional dialect. After modifications to a translation are received, these modification translations can be stored in the domain specific translation repository 130. This allows for later recall of the modified translations that are specific to the domain when additional translations are necessary.

The Domain Taxonomy Service 115 can interact with translation services 120 and translation repositories 125 stored in external storage 135. The external storage 135 can be a cloud storage system.

The translation service 120 can store various translated words or phrases in a domain specific translation repository 130. These translated words or phrases can be confirmed by local users or experts to verify the accuracy of the translation.

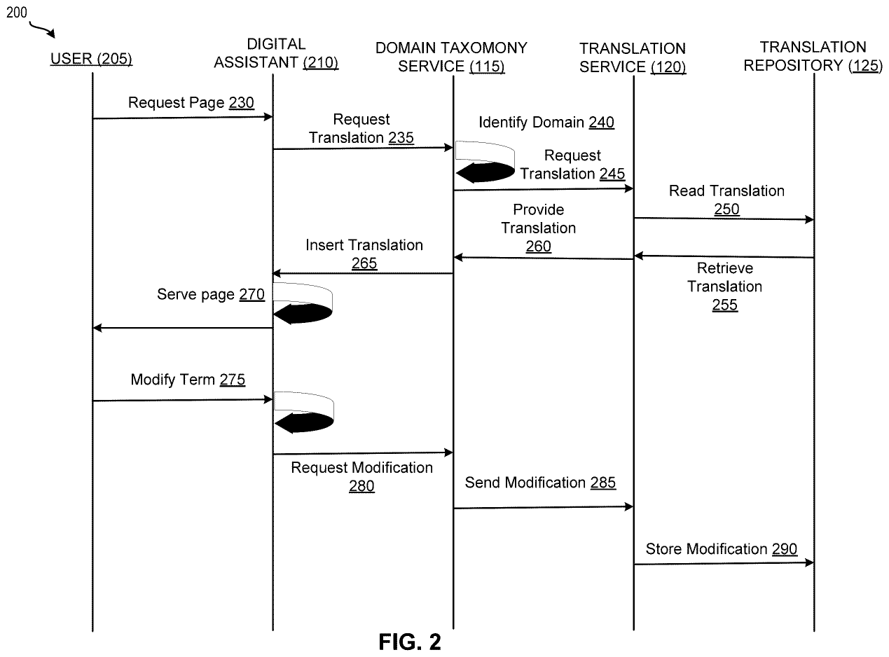

FIG. 2 is a notional swim lane diagram 200 for an exemplary process for artificial intelligence supported, real-time continuous delivery of multilingual content with learning and predictive functionality. FIG. 2 illustrates an exemplary use case incorporating the techniques within a web application.

In one example, a user 205 can, at step 230, request a webpage. The request can be transmitted from the user 205 using an electronic device via a wired or wireless network to a digital assistant 210. Requesting a webpage can involve a series of technical steps that take place between the client (usually a browser) and a web server. First, the client resolves the domain name (e.g., www. example. com) into an IP address using the Domain Name System (DNS). This process can be known as DNS Lookup. The DNS resolver may query recursive DNS servers and authoritative DNS servers to get the correct IP address.

Once the Internet Protocol address is known, the client establishes a connection with the web server hosting the webpage. For HTTP/1.1 or HTTP/2 over TCP, a TCP handshake (3-way handshake) is performed by the client device sending a SYN packet to the server, the server responding with a SYN-ACK packet, and the client device sending an ACK packet to confirm the connection. For HTTPS, an additional TLS/SSL handshake occurs as the client device and server exchange cryptographic keys and certificates to establish a secure channel.

The client device can send an HTTP/HTTPS request to the server using the established connection. The request can contain the request method: (e.g., GET, POST, PUT), request headers (e.g., Metadata about the request (e.g., User-Agent, Accept, Authorization), and a request body (if applicable, e.g., for POST or PUT requests).

The web server can receive and process the request. The web server can retrieve the requested resource (e.g., an HTML file, an image, or data from a database). The web server can execute server-side code (e.g., PHP, Python, Node. js) to generate a dynamic response.

The server can send back an HTTP response, which includes status code: (e.g., 200 OK, 404 Not Found, 500 Internal Server Error), response headers (e.g., metadata about the response (e.g., Content-Type, Content-Length, Cache-Control), and a response body (e.g., the content of the webpage (e.g., HTML, CSS, JavaScript, JSON)).

The client device (web browser) can parse the HTML, requests additional resources (CSS, JavaScript, images) referenced in the HTML via separate HTTP requests, and executes JavaScript and applies stylesheets to render the final webpage. For HTTP/1.1, the connection can be kept alive by default for reuse unless specified otherwise (Connection: close). For HTTP/2, multiple streams can operate over the same connection. The connection is eventually closed when no longer needed.

This process can repeat for every request made by the client, such as for images, scripts, and other resources. Advanced techniques like caching, load balancing, and content delivery networks (CDNs) can optimize these steps.

The digital assistant 210 can, at step 235, request the translation from a domain taxonomy service 115 as described above. The domain taxonomy service 115 can receive the translation request from the digital assistant 210.

A domain taxonomy service 115 can, at step 240, identify a domain for translating content by analyzing various attributes of the content and its context. This is particularly important in machine translation, personalization, or search optimization, where different domains (e.g., medical, legal, or technical) have distinct terminology and style requirements. This process can begin by examining the content to extract key features for domain classification. The key features can include but are not limited to keywords and phrases that can identify domain-specific terms (e.g., “hematology” can suggest medical content), N-gram Analysis (e.g., searching for patterns of word combinations typical of specific domains), Named Entity Recognition (NER) (e.g., detecting entities such as brands, product names, or scientific terms, and stylistic features (e.g., considering the tone, formality, and structure of the text).

The process for determining the domain can also include analyzing the metadata (e.g., title tags, meta descriptions, and author information). If the content includes structured data, the taxonomy service may also consider schema.org annotations.

The process for determining the domain can also include analyzing source and context. For example, the analyzing source and context can include analyzing the Domain Name and URL Structure for clues (e.g., med.example.com likely relates to medical content). This process can also include analyzing URL paths for indicators (e.g., /finance/ or /docs/legal/). This process can include using prior knowledge about the publisher or website to infer the domain (e.g., a post from a health blog is likely in the medical domain).

The process can include employing pre-trained natural language processing (NLP) models designed to classify domains. One example can include using transformer-based models (e.g., BERT, GPT) fine-tuned on domain-specific corpora. The models can predict the most likely domain based on the content.

Domain Taxonomy Mapping can be used to match the identified characteristics with a predefined taxonomy of domains. One example can include a taxonomy classifying content into categories like Technology, Medicine, Law, Education, etc. Hierarchical taxonomies may break domains into subcategories (e.g., Medicine with a subcategory of Oncology or Technology having a subcategory of Software Development).

In some systems, users or administrators can tag content manually or confirm/reject suggestions from the service to refine the classification. The service uses machine learning feedback loops to improve domain identification over time. The service can log misclassifications and corrections and update models with additional training data.

Once the domain has been identified, the domain taxonomy service 115 can, at step 245, request the translation from the translation service 120 as described above. The translation service 120 can use the identified domain to select the most appropriate translation for the content.

In various embodiments, the translation service 120 can access a translation repository 125 to search for a stored translation specific to the identified domain. The translation service 120 can use information specific to the domain (e.g., metadata) to find the most appropriate translation for the content. The translation service 120 can, at step 250, read the translation contained in the translation repository 125.

The translation service 120 can, at step 255, retrieve a stored translation specific to the domain from the translation repository 125. The translation service 120, at step 260, can provide the translation of the content to the domain taxonomy service 115. The domain taxonomy service 215 can, at step 265, insert the translation in place of the content to be accessed by digital assistant 210.

The digital assistant 210 can, at step 270, serve the page using the translation in place of the content. The user 205 can access the translated content on an electronic device.

In various embodiments, the user 205 can provide a first input indicating a request for modifying a displayed translation. In some instances, the translation provided may not be entirely accurate and a user can provide a second input indication a portion of the displayed translation that is not accurate. In various embodiments, the user 205 can be a designated user (e.g., an expert user) authorized to provide modifications to translations.

At step 275, the user 205 can modify the translation term. The digital assistant 210 can, at step 280, request modification of the term in the domain taxonomy service 115. The domain taxonomy service 115 can, at step 285, retrieve the modification from domain specific translation repository 130 via the translation service 120. The translation service 120, at step 290, can also store the modification in the translation repository 125.

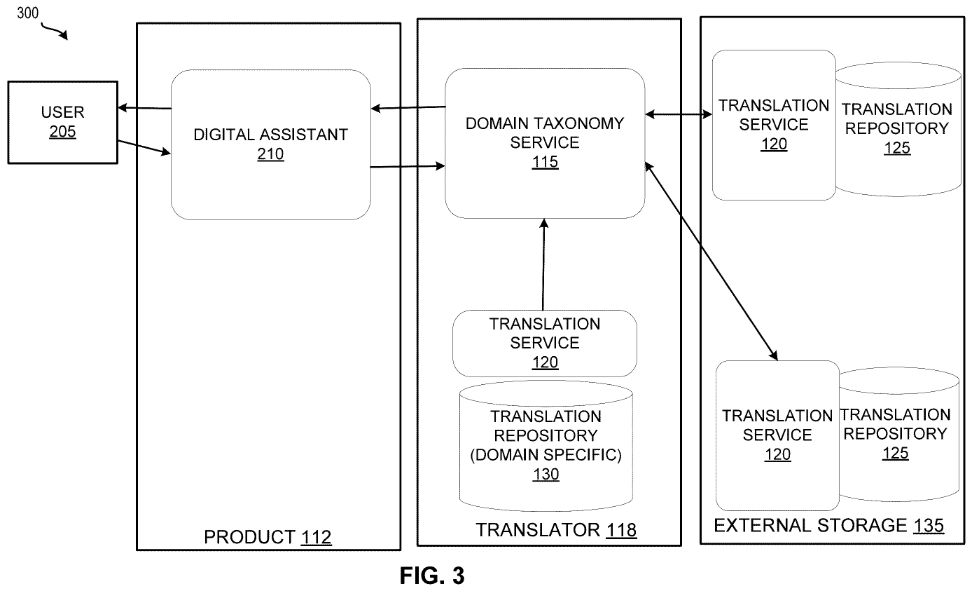

FIG. 3 illustrates an exemplary block diagram for a system 300 for implementing the techniques described herein. FIG. 3 illustrates an exemplary use case incorporating the techniques within a digital assistant (e.g., Joule, multimodal, Artificial Intelligent agent, etc.). In various embodiments, the system 300 can include a user 205, a product 112, a translator 118, and an external storage 135.

User 205 can access the system through an electronic device. Product 112 can be a software application (often just called an App). The software application can provide a multitude of services (e.g., financial, business, government, etc.).

A digital assistant 210 is a software-based system designed to assist users with tasks, answer questions, or perform functions based on voice, text, or other input. These assistants leverage artificial intelligence (AI), natural language processing (NLP), and machine learning to provide personalized, efficient, and context-aware interactions.

The digital assistant 210 can interact with Domain Taxonomy Service 115 that can be part of the translator 118. Translator 118 can be a cloud translator.

The Domain Taxonomy Service 115 can be a software system or service that manages, organizes, and provides access to a structured classification of information (taxonomy) within a specific domain or area of knowledge. It is often used to standardize how data is categorized and described across systems, facilitating consistency, interoperability, and easier data discovery. Domain Taxonomy Service 115 can store hierarchical or relational structures representing the categories, terms, or concepts in a domain. Some examples can include but are not limited to scientific classifications, product categories, industry-specific terminology. The Domain Taxonomy Service 115 can provide application programming interfaces or tools for querying and retrieving taxonomy data. It can allow users or systems to find terms, categories, or relationships efficiently. Domain Taxonomy Service 115 can be tailored to a particular area, such as healthcare, finance, e-commerce, education, or biology. For example, a taxonomy service for healthcare might classify diseases, symptoms, and treatments. The Domain Taxonomy Service 115 can track changes to taxonomies over time (e.g., adding unfamiliar terms, modifying relationships). It can ensure that updates are managed and approved to maintain consistency.

Domain Taxonomy Service 115 can ensure integration with other systems. For example, it can support applications like search engines, recommendation systems, analytics tools, or knowledge graphs. It can help standardize metadata, making data more interoperable across systems. The Domain Taxonomy Service 115 can support advanced structures, such as poly-hierarchies (where a concept belongs to multiple categories) or ontologies (which define relationships like “is a part of” or “is similar to”).

The Domain Taxonomy Service can utilize OWL (Web Ontology Language), RDF (Resource Description Framework), SKOS (Simple Knowledge Organization System). Some taxonomy Management Tools can include but are not limited to PoolParty, Ontotext, Synaptica, or open-source tools.

The translation service 120 can receive input (e.g., a textual input) in one language and translate the inputs into one or more different languages. The source of the default translation can (and will often be) a dynamic machine translation as described here. In some contexts (e.g., web pages) it could be a static translation (possibly machine-generated). These translations are static because it may be undesirable to have web pages to look different every time they are accessed. The concept of translation replacement through domain-based expert modifications as described below can apply to either static or dynamic translations. Training data can include datasets containing sentences in a source language paired with their translations in the target language. The input data can be tokenized or split into smaller units like words or sub words. The data can be cleaned and sometimes normalizes to remove noise and inconsistencies. In various embodiments, an encoder can convert the input source language into a sequence of numerical vectors (or representations). The encoder can be used to capture the semantic and syntactic meaning of the text. A decoder can be used to generate the translation into the target language. This can be done word-by-work. The decoder can use the encoded representation and previously generated words to predict the next word. Attention mechanisms can be used to allow the translation algorithm to focus on specific parts of the source sentence while generating each word in the translation. This can improve the quality of the translation, especially for long and complex sentences. Transformer models can be used such as but not limited to BERT, GPT, or T5 to replace traditional recurrent neural networks (RNNs) with self-attention mechanisms for better efficiency and parallelism. The transformer models can capture context over entire sentences or paragraphs, making translations more accurate and contextually relevant.

A domain specific translation repository 130 can store translated words or phrases that are specific to a language or regional dialect. The Domain Taxonomy Service 115 can interact with translation services 120 and translation repositories 125 stored in external storage 135. The external storage 135 can be a cloud storage system. The translation service 120 can store various translated words or phrases in a domain specific translation repository 130. The translation service 120 can also retrieve words or phrases from the domain specific translation repository 130. These translated words or phrases can be confirmed by local users or experts to verify the accuracy of the translation.

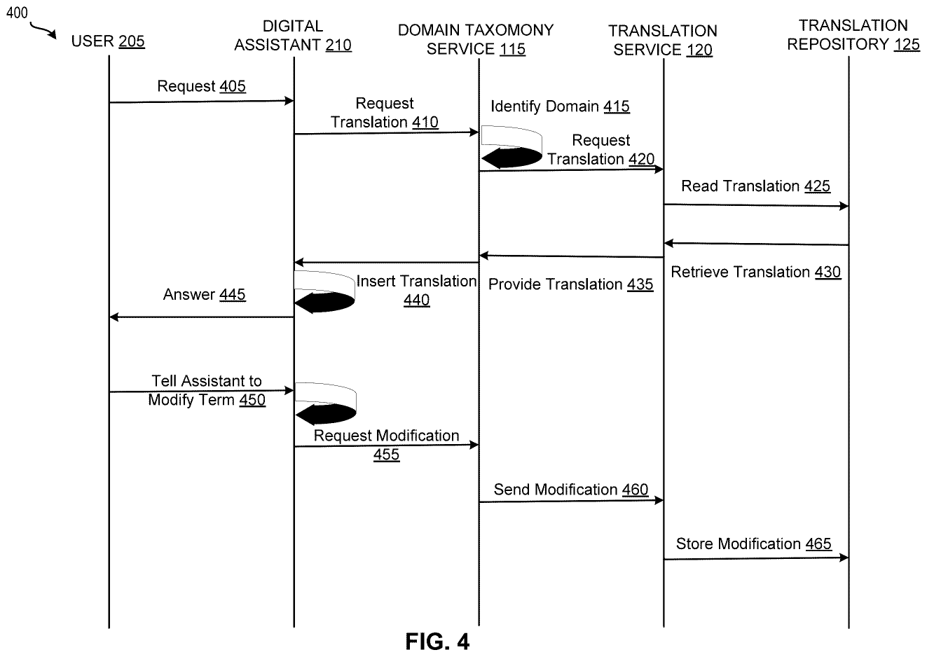

FIG. 4 is a notional swim lane diagram 400 for an exemplary process for artificial intelligence supported, real-time continuous delivery of multilingual content with learning and predictive functionality. FIG. 4 illustrates an exemplary use case incorporating the techniques within a digital assistant 210.

In one example, a user 205 can, at step 405, request a translation using a digital assistant 210. The request can be transmitted from a user 205 using an electronic device via a wired or wireless network to a digital assistant 210. The request can be transmitted from the digital assistant 210 to the domain taxonomy service 115.

The digital assistant 210 can, at step 410, request the translation from a domain taxonomy service 115 as described above. The domain taxonomy service 115 can receive the request from digital assistant 210.

A domain taxonomy service 115 can, at step 415, identify a domain for translating content by analyzing various attributes of the content and its context. This is particularly important in machine translation, personalization, or search optimization, where different domains (e.g., medical, legal, or technical) have distinct terminology and style requirements. This process can begin by examining the content to extract key features for domain classification. The key features can include but are not limited to keywords and phrases that can identify domain-specific terms (e.g., “hematology” can suggest medical content), N-gram Analysis (e.g., searching for patterns of word combinations typical of specific domains), Named Entity Recognition (NER) (e.g., detecting entities such as brands, product names, or scientific terms, and stylistic features (e.g., considering the tone, formality, and structure of the text). The taxonomy service is not restricted to just language in the determination. For example, the application types the user is working on might give important context. Financial apps vs medical apps may be one of the easiest ways to determine the domain for translation.

The process for determining the domain can also include analyzing the metadata (e.g., title tags, meta descriptions, and author information). If the content includes structured data, the taxonomy service may also consider schema. org annotations.

The process for determining the domain can also include analyzing source and context. For example, the analyzing source and context can include analyzing the Domain Name and URL Structure for clues (e.g., med.example.com likely relates to medical content). This process can also include analyzing URL paths for indicators (e.g., /finance/ or /docs/legal/). This process can include using prior knowledge about the publisher or website to infer the domain (e.g., a post from a health blog is likely in the medical domain).

The process can include employing pre-trained natural language processing (NLP) models designed to classify domains. One example can include using transformer-based models (e.g., BERT, GPT) fine-tuned on domain-specific corpora. The models can predict the most likely domain based on the content.

Domain Taxonomy Mapping can be used to match the identified characteristics with a predefined taxonomy of domains. One example can include a taxonomy classifying content into categories like Technology, Medicine, Law, Education, etc. Hierarchical taxonomies may break domains into subcategories (e.g., Medicine with a subcategory of Oncology or Technology having a subcategory of Software Development).

In some systems, users or administrators can tag content manually or confirm/reject suggestions from the service to refine the classification. The service uses machine learning feedback loops to improve domain identification over time. The service can log misclassifications and corrections and update models with additional training data.

Once the domain has been identified, the domain taxonomy service 115 can, at step 420, request the translation from the translation service 120 as described above. The translation service 120 can use the identified domain to select the most appropriate translation for the content. The translation service 120 can, at step 425, read the translation contained in the translation repository 125.

In various embodiments, the translation service 120 can access a translation repository 125 to search for a stored translation specific to the identified domain. The translation service 120 can use information specific to the domain (e.g., metadata) to find the most appropriate translation for the content.

The translation service 120 can, at step 430, retrieve a stored translation specific to the domain from the translation repository 125. The translation service 120, at step 435, can provide the translation of the content to the domain taxonomy service 115. The domain taxonomy service 115 can, at step 440, insert the translation in place of the content to be accessed by digital assistant 210.

The digital assistant 210 can, at step 445, provide the requested translation to the user 205. The user 205 can access the translated content on an electronic device.

In various embodiments, the user 205 can provide a first input indicating a request for modifying a displayed translation. In some instances, the translation provided may not be entirely accurate and a user can provide a second input indication a portion of the displayed translation that is not accurate. In various embodiments, the user 205 can be a designated user (e.g., an expert user) authorized to provide modifications to translations.

At step 450, the user 205 can instruct the digital assistant 210 to modify the translation term. The digital assistant 210 can, at step 455, request modification of the term in the domain taxonomy service 115. The domain taxonomy service 115 can, at step 460, send the modification to the translation service 120. The translation service 120, at step 465, can store the modification in the translation repository 125.

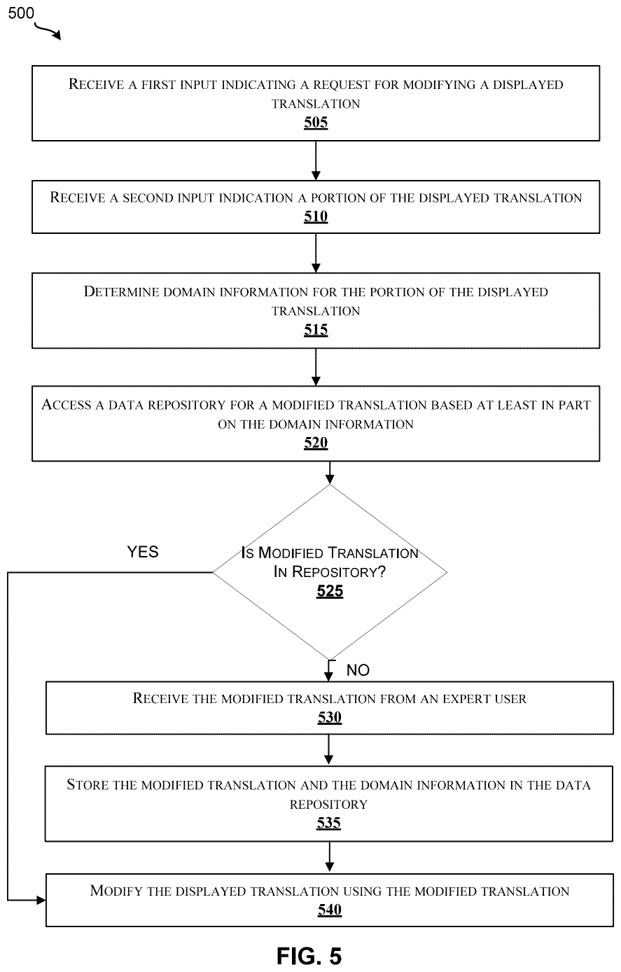

FIG. 5 illustrates a flowchart for a process 500 for artificial intelligence supported, real-time continuous delivery of multilingual content with learning and predictive functionality. In some implementations, one or more process blocks of FIG. 5 may be performed by a computing device.

At block 505, process 500 may include receiving a first input indicating a request for modifying a displayed translation. For example, computing devices may receive a first input indicating a request for modifying a displayed translation, as described above. The first input can include selecting a softkey on a graphical user interface (e.g., a softkey labeled “Modify” or “Modify Translation” or some variation). In various embodiments, first input can include any combination of button inputs and/or gesture inputs on a touch screen. In various embodiments, the first input can include a voice or an audio input. In various embodiments, the first input can be received using a chatbot. In various inputs, the first input can be a keyboard or pointing device input.

At block 510, process 500 may include receiving a second input indicating a portion of the displayed translation. For example, computing devices may receive the second input indicating a portion of the displayed translation, as described above. The second include can include a selecting text or a portion of text on a graphical user interface. In various embodiments, second input can include any combination of button inputs and/or gesture inputs on a touch screen. In various embodiments, the second input can include a voice or an audio input. In various embodiments, the second input can be received using a chatbot. In various inputs, the second input can be a keyboard or pointing device input.

In various embodiments, one of the first input and the second input is received via a chatbot.

At block 515, process 500 may include determining domain information for the portion of the displayed translation. For example, computing devices may determine domain information for the portion of the displayed translation, as described above. A Domain Taxonomy Service 115 as described above can be used to determine the domain information. The domain information can be stored and referenced by a translation service 120 to determine translations consistent with the relevant domain information.

In various embodiments, the domain information comprises metadata associated with a term of the modified translation. The process 500 may further include accessing an edit mode for the displayed translation, and displaying a button to modify the displayed translation, wherein the first input is received from selected the button.

In various embodiments, process 500 includes using one or more browser plug-ins to receive the first input and the second input to modify the displayed translation; and connecting to a domain service to receive the modified translation.

In various embodiments, the determining domain information for the portion of the displayed translation is based at least in part on a type of application for the displayed translation.

At block 520, process 500 may include accessing a data repository for a modified translation based at least in part on the domain information. For example, computing devices may access a data repository for a modified translation based at least in part on the domain information, as described above. The data repository can store relevant translations linked to specific domains. The storage and retrieval of relevant translations can make the translation faster and more accurate.

In various embodiments, the modified translation is based in part on a specific locality for the displayed translation.

At block 525, process 500 may include determining if the modified translation is stored in a repository. A search process using the domain information can be used to determine a modified translation.

At block 530, when the modified translation is not stored in a repository, process 500 may include receiving the modified translation from an expert user. An expert user can submit the modified translation using several available means. For example, the expert user can enter the modified translation through a keyboard, voice input, and a chatbot entry. The expert is native speaker and topic expert, this means for that he/she knows the best possible translation and can use it if the proposed translation is not the best one.

At block 535, process 500 may include storing the modified translation and the domain information in the data repository. For example, computing devices may receive the modified translation from an expert user; store the modified translation and the domain information in the data repository, as described above. In various embodiments, the data repository can be a cloud storage system. At block 540, process 500 may include modifying the displayed translation using the modified translation. For example, computing devices may modify the displayed translation using the modified translation, as described above. In one example, the domain taxonomy service retrieves the default translation for the text (e.g., likely a machine translation, but the source does not matter here). Next, the domain taxonomy service retrieves translations modified by experts for the particular domain. Then, the original translations are replaced with the modified translations where one exists. The new, modified translation is sent to the user.

For example: “well” translates in German to “Brunnen” in the usual context of “place to get water.” In the context of the oil and gas industry it translates to “Bohrloch.” Here a machine translation without context might easily have translated a web page in the oil and gas context using “Brunnen.” An expert later modified it to the correct “Bohrloch.”

The taxonomy service has the original, and retrieves the default translation, then inserts the modifications done by an expert before serving the entire translation to the user.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Process 500 may include additional implementations, such as any single implementation or any combination of implementations described below and/or in connection with one or more other processes described elsewhere herein.

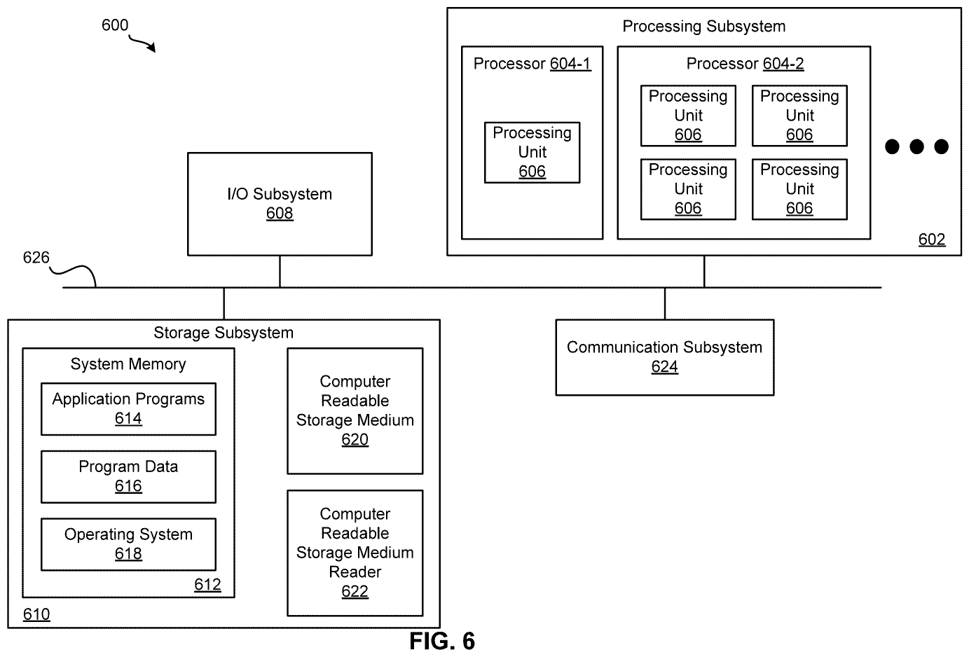

FIG. 6 illustrates a computer system 600 for implementing various embodiments described above. Computer system 600 may be a desktop computer, a laptop, a server computer, or any other type of computer system or combination thereof. In addition, computer system 600 can implement many of the operations, methods, and/or processes described above (e.g., process 500). As shown in FIG. 6, computer system 600 includes processing subsystem 602, which communicates, via bus subsystem 626, with input/output (I/O) subsystem 608, storage subsystem 610 and communication subsystem 624.

Bus subsystem 626 is configured to facilitate communication among the various components and subsystems of computer system 600. While bus subsystem 626 is illustrated in FIG. 6 as a single bus, one of the ordinary skill in the art will understand that bus subsystem 626 may be implemented as multiple buses. Bus subsystem 626 may be any of several types of bus structures (e.g., a memory bus or memory controller, a peripheral bus, a local bus, etc.) using any of a variety of bus architectures. Examples of bus architecture may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 602, which can be implemented as one or more integrated circuits (e.g., a conventional microprocessor or microcontroller), controls the operation of computer system 600. Processing subsystem 602 may include one or more processors 604. Each processor 604 may include one processing unit 606 (e.g., a single core processor such as processor 604-1) or several processing units 606 (e.g., a multicore processor such as processor 604-2). In some embodiments, processors 604 of processing subsystem 602 may be implemented as independent processors while, in other embodiments, processors 604 of processing subsystem 602 may be implemented as multiple processors integrate into a single chip or multiple chips. Still, in some embodiments, processors 604 of processing subsystem 602 may be implemented as a combination of independent processors and multiple processors integrated into a single chip or multiple chips.

In some embodiments, processing subsystem 602 can execute a variety of programs or processes in response to program code and can maintain multiple concurrently executing programs or processes. At any given time, some or all of the program code to be executed can reside in processing subsystem 602 and/or in storage subsystem 610. Through suitable programming, processing subsystem 602 can provide various functionalities, such as the functionalities described above by reference to process 500.

I/O subsystem 608 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 600 to a user or another device (e.g., a printer).

As illustrated in FIG. 6, storage subsystem 610 includes system memory 612, computer-readable storage medium 620, and computer-readable storage medium reader 622. System memory 612 may be configured to store software in the form of program instructions that are loadable and executable by processing subsystem 602 as well as data generated during the execution of program instructions. In some embodiments, system memory 612 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 612 may include several types of memory, such as static random-access memory (SRAM) and/or dynamic random-access memory (DRAM). System memory 612 may include a basic input/output system (BIOS), in some embodiments, which is configured to store basic routines to facilitate transferring information between elements within computer system 600 (e.g., during start-up). Such a BIOS may be stored in ROM (e.g., a ROM chip), flash memory, or any other type of memory that may be configured to store the BIOS.

As shown in FIG. 6, system memory 612 includes application programs 614, program data 616, and operating system (OS) 618. OS 618 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 620 may be a non-transitory computer-readable medium configured to store software (e.g., programs, code modules, data constructs, instructions, etc.). Many of the components and/or processes (e.g., process 500) described above may be implemented as software that when executed by a processor or processing unit (e.g., a processor or processing unit of processing subsystem 602) performs the operations of such components and/or processes. Storage subsystem 610 may also store data used for, or generated during, the execution of the software.

Storage subsystem 610 may also include computer-readable storage medium reader 622 that is configured to communicate with computer-readable storage medium 620. Together and optionally, in combination with system memory 612, computer-readable storage medium 620 may comprehensively represent remote, local, fixed, and/or removable storage devices plus storage media for temporarily and/or more permanently containing, storing, transmitting, and retrieving computer-readable information.

Computer-readable storage medium 620 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 624 serves as an interface for receiving data from, and transmitting data to other devices, computer systems, and networks. For example, communication subsystem 624 may allow computer system 600 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 624 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 624 may provide components configured for wired communication (e.g., Ethernet) in addition to or instead of components configured for wireless communication.

One of the ordinary skill in the art will realize that the architecture shown in FIG. 6 is only an example architecture of computer system 600, and that computer system 600 may have additional or fewer components than shown, or a different configuration of components. The various components shown in FIG. 6 may be implemented in hardware, software, firmware, or any combination thereof, including one or more signal processing and/or application specific integrated circuits.

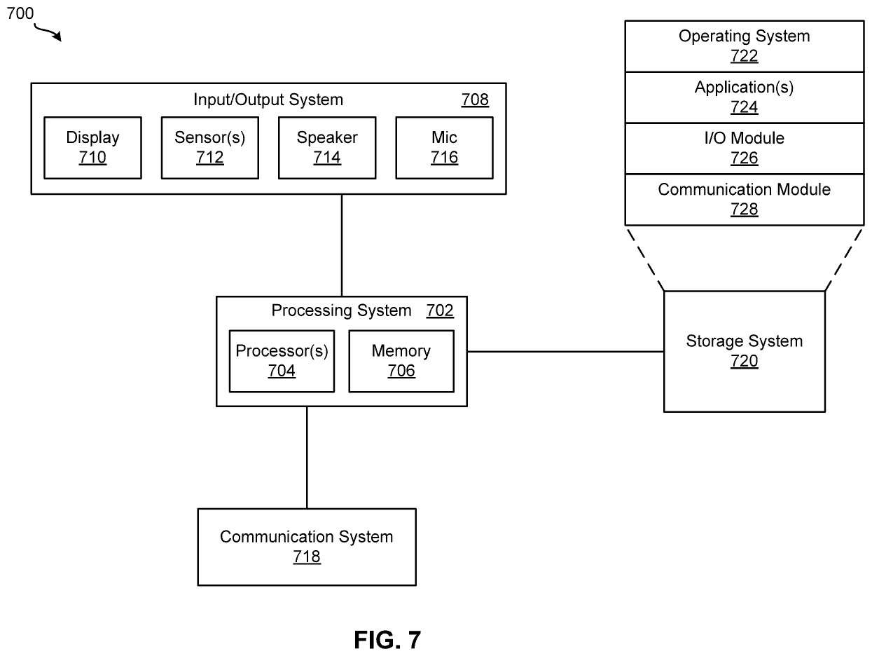

FIG. 7 illustrates an exemplary computing device 700 for implementing various embodiments described above. Computing device 700 may be a cellphone, a smartphone, a wearable device, an activity tracker or manager, a tablet, a personal digital assistant (PDA), a media player, or any other type of mobile computing device or combination thereof. In addition, computing device 700 can implement many of the operations, methods, and/or processes described above (e.g., process 500). As shown in FIG. 7, computing device 700 includes processing system 702, input/output (I/O) system 708, communication system 718, and storage system 720. These components may be coupled by one or more communication buses or signal lines.

Processing system 702, which can be implemented as one or more integrated circuits (e.g., a conventional microprocessor or microcontroller), controls the operation of computing device 700. As shown, processing system 702 includes one or more processors 704 and memory 706. Processors 704 are configured to run or execute various software and/or sets of instructions stored in memory 706 to perform various functions for computing device 700 and to process data.

Each processor of processors 704 may include one processing unit (e.g., a single core processor) or several processing units (e.g., a multicore processor). In some embodiments, processors 704 of processing system 702 may be implemented as independent processors while, in other embodiments, processors 704 of processing system 702 may be implemented as multiple processors integrated into a single chip. Still, in some embodiments, processors 704 of processing system 702 may be implemented as a combination of independent processors and multiple processors integrated into a single chip.

Memory 706 may be configured to receive and store software (e.g., operating system 722, applications 724, I/O module 726, communication module 728, etc. from storage system 720) in the form of program instructions that are loadable and executable by processors 704 as well as data generated during the execution of program instructions. In some embodiments, memory 706 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 708 is responsible for receiving input through various components and providing output through various components. As shown for this example, I/O system 708 includes display 710, one or more sensors 712, speaker 714, and microphone 716. Display 710 is configured to output visual information (e.g., a graphical user interface (GUI) generated and/or rendered by processors 704). In some embodiments, display 710 is a touch screen that is configured to also receive touch-based input. Display 710 may be implemented using liquid crystal display (LCD) technology, light-emitting diode (LED) technology, organic LED (OLED) technology, organic electro luminescence (OEL) technology, or any other type of display technologies. Sensors 712 may include any number of several types of sensors for measuring a physical quantity (e.g., temperature, force, pressure, acceleration, orientation, light, radiation, etc.). Speaker 714 is configured to output audio information and microphone 716 is configured to receive audio input. One of the ordinary skill in the art will appreciate that I/O system 708 may include any number of additional, fewer, and/or different components. For instance, I/O system 708 may include a keypad or keyboard for receiving input, a port for transmitting data, receiving data and/or power, and/or communicating with another device or component, an image capture component for capturing photos and/or videos, etc.

Communication system 718 serves as an interface for receiving data from, and transmitting data to, other devices, computer systems, and networks. For example, communication system 718 may allow computing device 700 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 718 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 718 may provide components configured for wired communication (e.g., Ethernet) in addition to or instead of components configured for wireless communication.

Storage system 720 handles the storage and management of data for computing devices 700. Storage system 720 may be implemented by one or more non-transitory machine-readable mediums that are configured to store software (e.g., programs, code modules, data constructs, instructions, etc.) and store data used for, or generated during, the execution of the software. Many of the components and/or processes (e.g., process 500) described above may be implemented as software that when executed by a processor or processing unit (e.g., processors 704 of processing system 702) perform the operations of such components and/or processes.

In this example, storage system 720 includes operating system 722, one or more applications 724, I/O module 726, and communication module 728. Operating system 722 includes various procedures, sets of instructions, software components and/or drivers for controlling and managing general system tasks (e.g., memory management, storage device control, power management, etc.) and facilitates communication between various hardware and software components. Operating system 722 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 724 can include any number of different applications installed on computing device 700. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 726 manages information received via input components (e.g., display 710, sensors 712, and microphone 716) and information to be outputted via output components (e.g., display 710 and speaker 714). Communication module 728 facilitates communication with other devices via communication system 718 and includes various software components for handling data received from communication system 718.

One of ordinary skill in the art will realize that the architecture shown in FIG. 7 is only an example architecture of computing device 700, and that computing device 700 may have additional or fewer components than shown, or a different configuration of components. The various components shown in FIG. 7 may be implemented in hardware, software, firmware, or any combination thereof, including one or more signal processing and/or application specific integrated circuits.

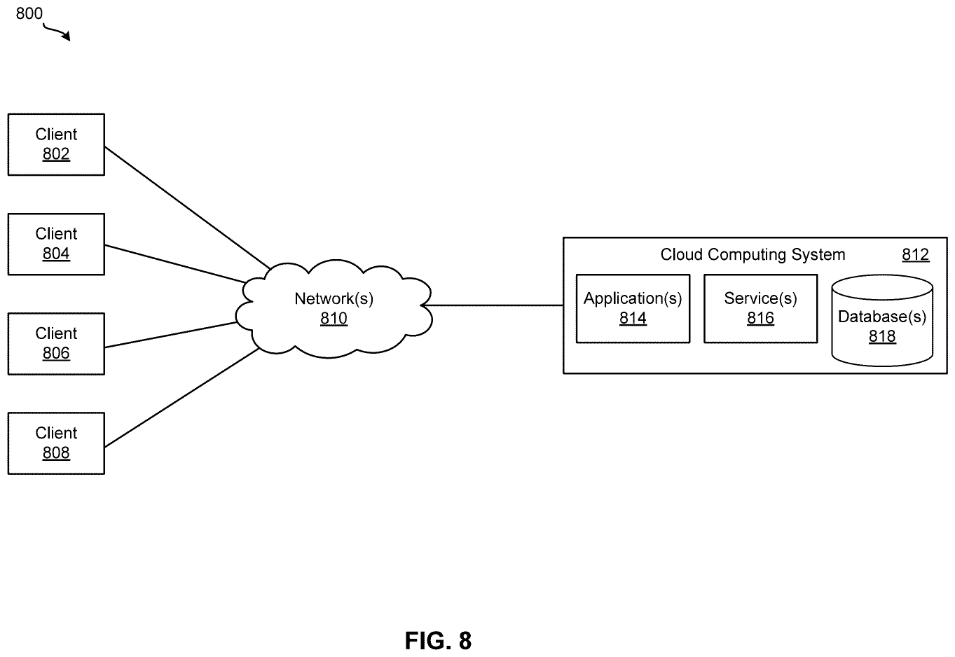

FIG. 8 illustrates an exemplary system 800 for implementing various embodiments described above. For example, any client devices 802, 804, 806, 808 may be used to implement the cloud computing system 812. As shown, system 800 includes client devices 802, 804, 806, and 808, one or more networks 810, and cloud computing system 812. Cloud computing system 812 is configured to provide resources and data to client devices 802, 804, 806, and 808 via networks 810. In some embodiments, cloud computing system 812 provides resources to any number of different users (e.g., customers, tenants, organizations, etc.). Cloud computing system 812 may be implemented by one or more computer systems (e.g., servers), virtual machines operating on a computer system, or a combination thereof.

As shown, cloud computing system 812 includes one or more applications 814, one or more services 816, and one or more databases 818. Cloud computing system 812 may provide applications 814, services 816, and databases 818 to any number of different customers in a self-service, subscription-based, elastically scalable, reliable, highly available, and secure manner.

In some embodiments, cloud computing system 812 may be adapted to automatically provision, manage, and track a customer's subscriptions to services offered by cloud computing system 812. Cloud computing system 812 may provide cloud services via different deployment models. For example, cloud services may be provided under a public cloud model in which cloud computing system 812 is owned by an organization selling cloud services and the cloud services are made available to the public or different industry enterprises. As another example, cloud services may be provided under a private cloud model in which cloud computing system 812 is operated solely for a single organization and may provide cloud services for one or more entities within the organization. The cloud services may also be provided under a community cloud model in which cloud computing system 812 and the cloud services provided by cloud computing system 812 are shared by several organizations in a related community. The cloud services may also be provided under a hybrid cloud model, which is a combination of two or more of the aforementioned different models.

In some instances, any one of applications 814, services 816, and databases 818 made available to client devices 802, 804, 806, and -808 via networks 810 from cloud computing system 812 is referred to as a “cloud service.” Typically, servers and systems that make up cloud computing system 812 are different from the on-premises servers and systems of a customer. For example, cloud computing system 812 may host an application and a user of one of client devices 802-808 may order and use the application via networks 810.

Applications 814 may include software applications that are configured to execute on cloud computing system 812 (e.g., a computer system or a virtual machine operating on a computer system) and be accessed, controlled, managed, etc. via client devices 802-808. In some embodiments, applications 814 may include server applications and/or mid-tier applications (e.g., HTTP (hypertext transfer protocol) server applications, FTP (file transfer protocol) server applications, CGI (common gateway interface) server applications, JAVA server applications, etc.). Services 816 are software components, modules, applications, etc. that are configured to execute on cloud computing system 812 and provide functionalities to client devices 802-808 via networks 810. Services 816 may be web-based services or on-demand cloud services.

Databases 818 are configured to store and/or manage data that is accessed by applications 814, services 816, and/or client devices 802-808. For instance, the customer sales data may be stored in databases 818. Databases 818 may reside on a non-transitory storage medium local to (and/or resident in) cloud computing system 812, in a storage-area network (SAN), on a non-transitory storage medium local located remotely from cloud computing system 812. In some embodiments, databases 818 may include relational databases that are managed by a relational database management system (RDBMS). Databases 818 may be a column-oriented databases, row-oriented databases, or a combination thereof. In some embodiments, some or all of databases 818 are in-memory databases. That is, in some such embodiments, data for databases 818 are stored and managed in memory (e.g., random access memory (RAM)).

Client devices 802-808 are configured to execute and operate a client application (e.g., a web browser, a proprietary client application, etc.) that communicates with applications 814, services 816, and/or databases 818 via networks 810. This way, client devices 802-808 may access the various functionalities provided by applications 814, services 816, and databases 818 while applications 814, services 816, and databases 818 are operating (e.g., hosted) on cloud computing system 812. Although system 800 is shown with four client devices, any number of client devices may be supported.

Networks 810 may be any type of network configured to facilitate data communications among client devices (e.g., first client device 802, second client device 804, third client device 806, and fourth client device 808) and cloud computing system 812 using any of a variety of network protocols. Networks 810 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments and are presented to illustrate the flexibility and advantages of various embodiments of the present disclosure as defined by the following claims. Based on the above disclosure and the following claims, other arrangements, embodiments, implementations, and equivalents will be evident to those skilled in the art and may be employed without departing from the spirit and scope of the present disclosure as defined by the claims.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or” unless explicitly stated otherwise (e.g., if used in combination with “either” or “only one of”).

What is claimed is:

1. A computer implemented method comprising:
receiving a first input indicating a request for modifying a displayed translation;
receiving a second input indicating a portion of the displayed translation;
determining domain information for the portion of the displayed translation;
accessing a data repository for a modified translation based at least in part on the domain information;
when the modified translation is not stored in the data repository:
receiving the modified translation from an expert user;
storing the modified translation and the domain information in the data repository; and
modifying the displayed translation using the modified translation.

2. The computer implemented method of claim 1, wherein the domain information comprises metadata associated with a term of the modified translation.

3. The computer implemented method of claim 1, further comprising:
accessing an edit mode for the displayed translation; and
displaying a button to modify the displayed translation, wherein the first input is received from selected the button.

4. The computer implemented method of claim 1, further comprising:
using one or more browser plug-ins to receive the first input and the second input to modify the displayed translation; and
connecting to a domain service to receive the modified translation.

5. The computer implemented method of claim 1, wherein the determining domain information for the portion of the displayed translation is based at least in part on a type of application for the displayed translation.

6. The computer implemented method of claim 1, wherein the modified translation is based in part on a specific locality for the displayed translation.

7. The computer implemented method of claim 1, one of the first input and the second input is received via a chatbot.

8. A non-transitory computer-readable medium storing a set of instructions, the set of instructions comprising:
one or more instructions that, when executed by one or more processors of a device, cause the device to perform operations comprising:
receiving a first input indicating a request for modifying a displayed translation;
receiving a second input indicating a portion of the displayed translation;
determining domain information for the portion of the displayed translation;
accessing a data repository for a modified translation based at least in part on the domain information;
when the modified translation is not stored in the data repository:
receiving the modified translation from an expert user;
storing the modified translation and the domain information in the data repository; and
modifying the displayed translation using the modified translation.

9. The non-transitory computer-readable medium of claim 8, wherein the domain information comprises metadata associated with a term of the modified translation.

10. The non-transitory computer-readable medium of claim 8, wherein the operations further comprise:
accessing an edit mode for the displayed translation; and
displaying a button to modify the displayed translation, wherein the first input is received from selected the button.

11. The non-transitory computer-readable medium of claim 8, wherein the operations further comprise:
using one or more browser plug-ins to receive the first input and the second input to modify the displayed translation; and
connecting to a domain service to receive the modified translation.

12. The non-transitory computer-readable medium of claim 8, wherein the determining domain information for the portion of the displayed translation is based at least in part on a type of application for the displayed translation.

13. The non-transitory computer-readable medium of claim 8, wherein the modified translation is based in part on a specific locality for the displayed translation.

14. The non-transitory computer-readable medium of claim 8, wherein one of the first input and the second input is received via a chatbot.

15. A system comprising:
one or more processors configured to access code stored in a memory to perform operations comprising:
receiving a first input indicating a request for modifying a displayed translation;
receiving a second input indicating a portion of the displayed translation;
determining domain information for the portion of the displayed translation;
accessing a data repository for a modified translation based at least in part on the domain information;
when the modified translation is not stored in the data repository:
receiving the modified translation from an expert user;
storing the modified translation and the domain information in the data repository; and
modifying the displayed translation using the modified translation.

16. The system of claim 15, wherein the domain information comprises metadata associated with a term of the modified translation.

17. The system of claim 15, wherein the operations further comprise:
accessing an edit mode for the displayed translation; and
displaying a button to modify the displayed translation, wherein the first input is received from selected the button.

18. The system of claim 15, wherein the operations further comprise:
using one or more browser plug-ins to receive the first input and the second input to modify the displayed translation; and
connecting to a domain service to receive the modified translation.

19. The system of claim 15, wherein the determining domain information for the portion of the displayed translation is based at least in part on a type of application for the displayed translation.

20. The system of claim 15, wherein the modified translation is based in part on a specific locality for the displayed translation.
